(19) United States
(12) Patent Application Publication
(10) Pub. No.: US 2014/0152297 A1
(43) Pub. Date: Jun. 5, 2014

(54) Comprehensive Motion Detector Switch

(71) Applicants: Rex A. Knepp, Everett, PA (US); Gary Wineland, Roaring Spring, PA (US)

(72) Inventors: Rex A. Knepp, Everett, PA (US); Gary Wineland, Roaring Spring, PA (US)

(21) Appl. No.: 13/794,694

(22) Filed: Mar. 11, 2013

Related U.S. Application Data
(60) Provisional application No. 61/685,535, filed on Mar. 20, 2012.

(51) Int. Cl. G01D 5/12

(52) U.S. Cl. CPC G01D 5/12
USPC 324/207.11

(57) ABSTRACT

The Comprehensive Motion Detector Switch (CMDS) is a device used to sense repetitive mechanical motion in an industrial environment. The rotation of a pulley on a conveyor would be a typical application. This CMDS device is unique in that is has no internal moving parts, has a non-critical target sensing distance, and provides multiple output signals. The CMDS provides a speed-switch output which gives indication that the target device is in motion. The speed-switch signal is switch selectable between a pulsed output or as a constant stop-switch output. Additionally there is a field programmable under-speed signal available. This signal will indicate when the target device slows by a fixed percentage of the programmed speed. Another feature is that the CMDS device is available in both hard-wired and wireless versions.

This is a regular patent application based on provisional patent application, filed Mar. 20, 2012 Application Ser. No. 61/685/535.

### BACKGROUND OF THE INVENTION

The present invention relates generally to a motion detection device and more specifically to a non-contact universal mounting motion detector device.

In the past history of motion detection, it has always been necessary to determine if motion occurs. Further, the presence of motion varies widely determined by the industry for which it was used. In the consumer field, motion devices are used to determine intruder presence, door and window status, etc, automatically turning on lights, sounding alarms, etc. In industry, motion devices are used to determine if equipment is actually in movement. The present invention will primarily be used in industry, although it could be used in the consumer field. That said, we will present the background in the field of industry.

Because it is necessary to determine if equipment used in industry are actually operating, there have been many devices used to determine motion. Some of these devices are smart sensors that detect the presence of metal. The metal, which is the target, when passed over the sensor activates it. These sensors are called proximity sensors because they only become active when the metal target is within the proximity limit of sensors detection. Other sensors are centrifugal sensors that when mounted on a turning shaft of equipment, only becomes active if the shaft is turning fast enough to overcome the sensors centrifugal limit. Other sensors include Hall Effect, capacitance, light beam, laser and many more.

In determining what kind of senor to be used to monitor industrial equipment motion, many things have to be considered. If we consider a conveyor for example, there are many parts on the conveyor that actually move or turn when the conveyor is running. Most conveyors have a head and tail pulley that are mounted to a shaft that connects to the conveyor frame. Since these pulleys actually turn when the conveyor is running, so does the shaft they are mounted to. This would be an ideal place to mount a sensor because the turning shaft presents a place to mount a metal target for the sensor to detect. Further, once the conveyor shaft is determined to be the area to mount the target, the problem arises as to how to mount the sensor and also the target assembly.

Of course, industrial equipment has many other areas on such equipment where there is motion when the equipment is running. The example of a conveyor shaft was cited because it should be clear as to how the rotating shaft presents an ideal member for mounting a target for the motion detector.

### SUMMARY OF THE INVENTION

The primary object of the present invention is to provide a motion switch that has no internal moving parts.

Another object is to provide multiple outputs.

Another object is to provide a non-critical target sensing distance.

Another object is to provide a flexible/adjustable sensor conduit.

Another object is to provide a resilient sensor conduit.

Another object is to provide an optional wireless version.

Another object is to provide a sensing unit independent of the target assembly.

Another object is to provide a target assembly that uses a attachment magnet.

Another object is to provide a target assembly that has an embedded magnet as the target

Another object is to provide a circuit that provides both AC and DC outputs by applying just AC input power.

Other objects and advantages of the present invention will become apparent from the following descriptions, taken in connections with the accompanying drawings, wherein by way of illustrations and example, an embodiment of the present invention.

The drawings constitute a part of this specification and include exemplary embodiments in various forms. It is to be understood that in some instances, various aspects of the invention may be shown exaggerated or enlarged to facilitate an understanding of the invention.

### DETAILED DESCRIPTION OF THE PREFERRED EMBODIMENT

Detailed descriptions of the preferred embodiment are provided herein. It is to be understood, however, that the present invention may be embodied in various forms. Therein, specific details disclosed herein are not to be interpreted as limiting, but rather as a basis for the claims and as a representative basis for teaching one skilled in the art to employ the present invention in virtually any appropriate detailed system, structure or manner.

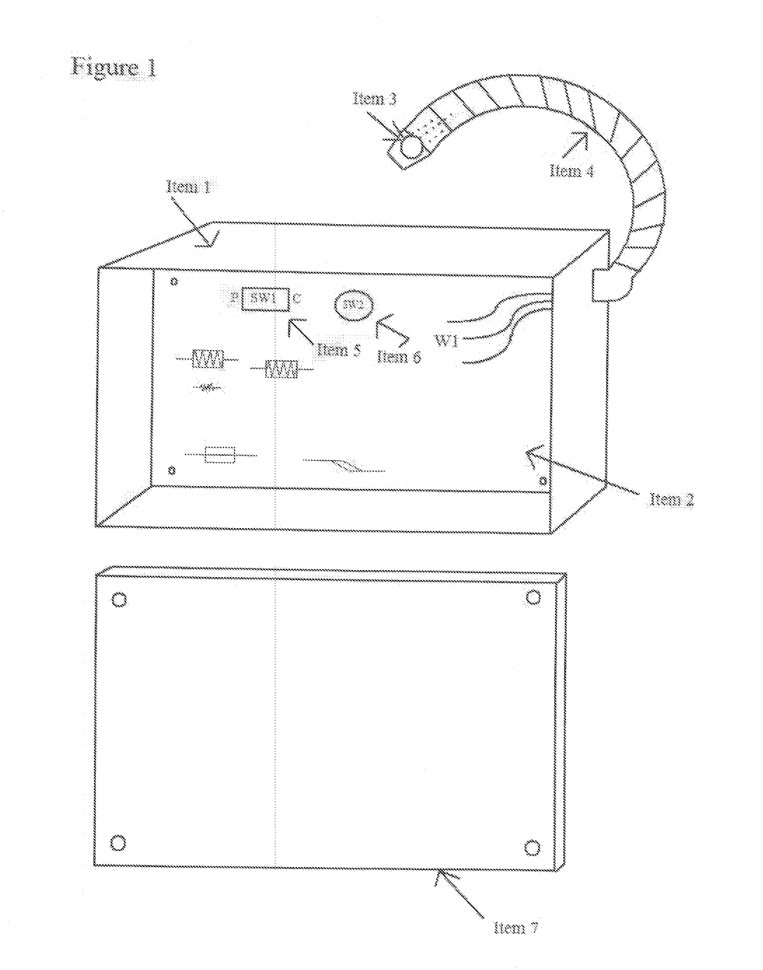

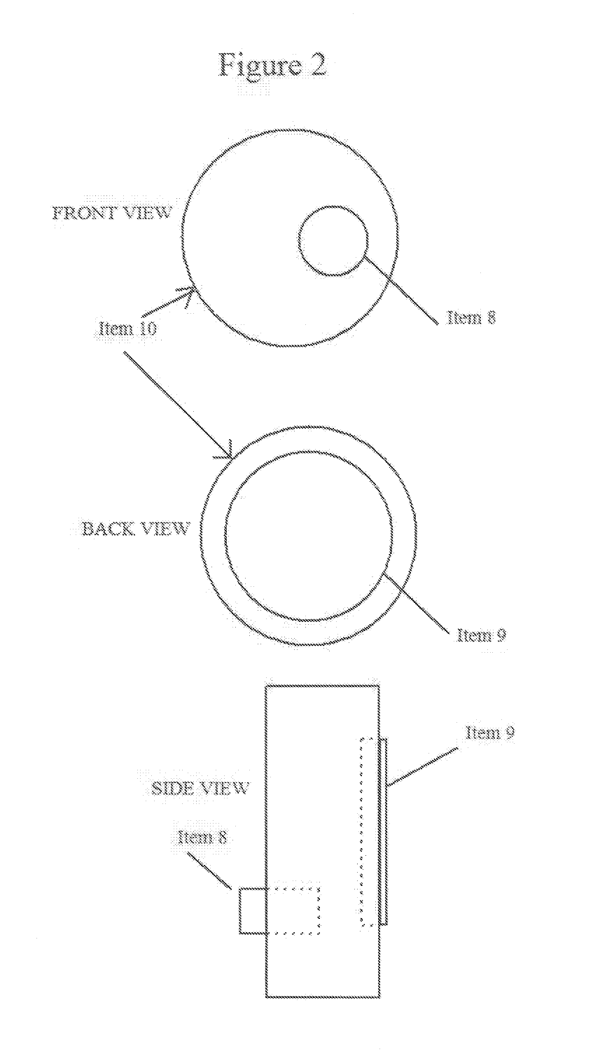

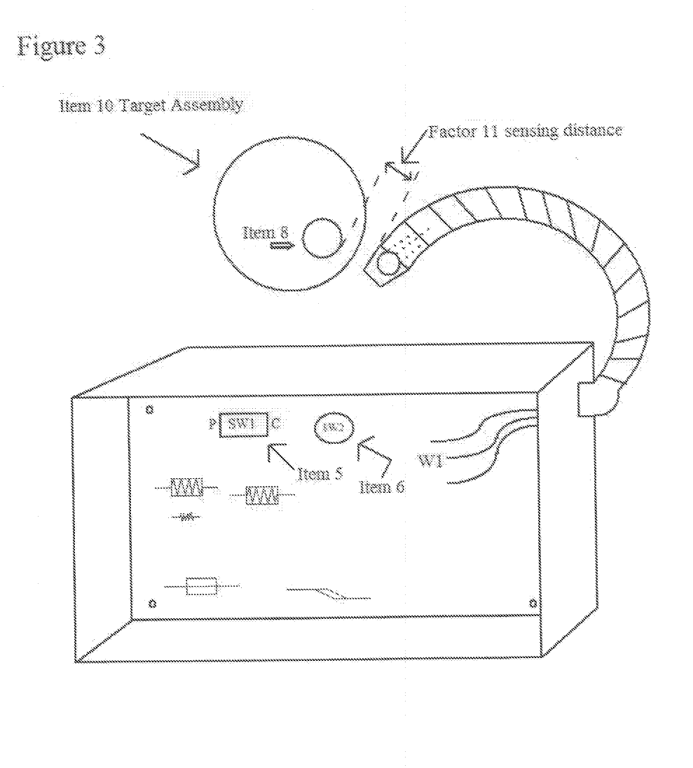

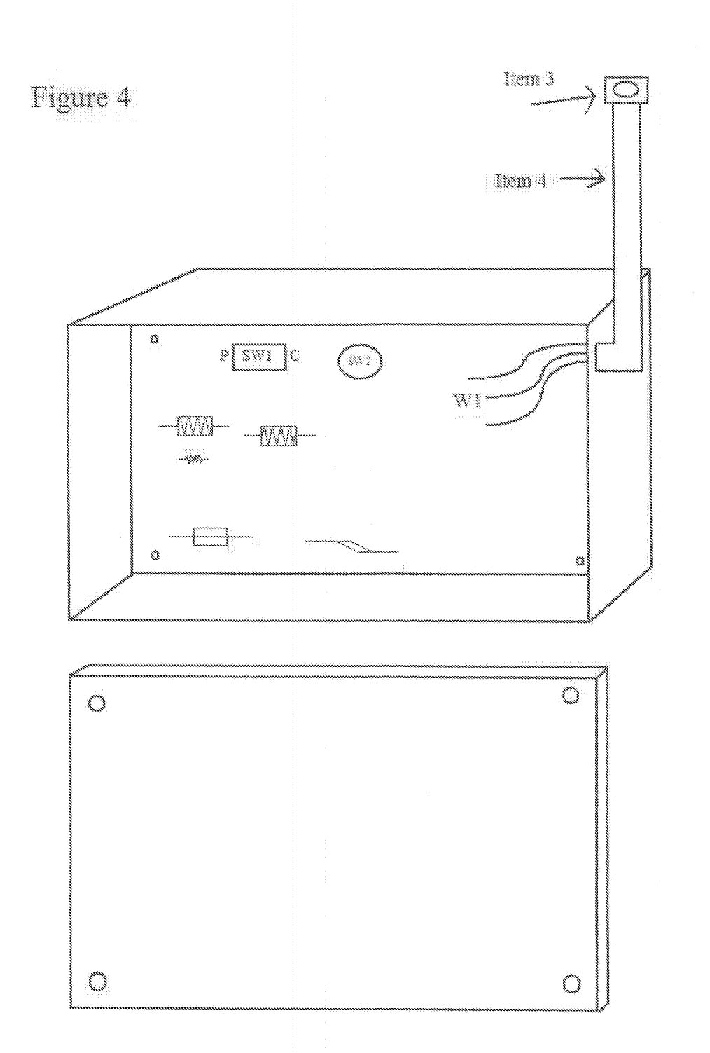

The preferred embodiment can be explained further by referring to FIG. 1 and FIG. 2. Referring to FIG. 1, it can be seen that item 1 is a standard electrical enclosure. Item 7 is a cover for item 1. This enclosure can be made of numerous materials used in the industry. Materials such as steel, fiberglass, aluminum and plastic could be used for such purpose. Item 1 is used to contain item 2 which is a fabricated circuit board designed specifically for the current invention. Item 2, it should be noted, shows only a few components. These components are being shown as a representative of a circuit board and are not be an exact representative of the current invention's circuit board. Continuing, item 4 is a flexible conduit which houses item 3 sensor and its associated connecting wires. It should be noted that item 4 could also be a resilient conduit. FIG. 4 shows item 4 as a resilient conduit. Item 4 as shown in FIG. 4 would be described as one that retains or goes back to its original shape and position even if forces caused the resilient item 4 to bend or flex. FIG. 1 shows item 4 as being flexible and will retain its conformed shape once it has been adjusted. Referring back to FIG. 4, item 4 is being shown as a resilient material. In most cases, a resilient material is rubber although other flexible material could be used. Item 3 sensor shown in FIG. 1 and FIG. 4 has connecting wires W1 which are also inside item 4 regardless if item 4 is flexible or resilient and pass on to item 2 circuit board and are terminated. Item 3 sensor needs a target to sense so we will move on to FIG. 2. From FIG. 2 we see item 10 is a housing for item 8 target magnet and item 9 mounting magnet. Since item 9 attachment magnet and item 8 target magnet are permanently attached to item 10 housing, any movement of item 9 attachment magnet causes item 10 housing and item 8 target magnet to move in the same motion. Item 8 target magnet is the target that item 3 sensor senses. Item 9 is the mounting magnet for item 10 housing. When item 10 housing is mounted to a turning shaft due to item 9 mounting magnet attractions to a steel shaft, because item 8 target is off center of item 10, an eccentric motion of item 8 target occurs. Turning to FIG. 3, the reader will understand the importance of item 8 being off center of item 10. In FIG. 3, factor 11 is shown as a distance representative of when item 3 sensor detects presence of item 8 target magnet. In FIG. 3 it can be shown that item 8 is close enough to item 3 so that item 3 will sense item 8 and become active. As item 10 turns in a clockwise or counter clockwise direction, item 8 will also turn because it is attached to item 10. This turning movement causes factor 11 between item 8 and item 3 to increase and thus item 3 will deactivate because the sensing distance becomes greater than item 3 can detect. It should be noted that item 10, item 8 and item 9 are packaged to present the end user a complete target adapter assembly but because item 3 senses only item 8 target magnet, the end user could use only item 8 for the purpose of detecting motion.

Turning to FIG. 1, we see item 2 circuit board incorporating item 5 slide switch and item 6 pushbutton switch. The purpose of item 5 slide switch is to change the output of item 2 from a pulse output to a constant output. It should be noted that item 2 circuit board sends a signal to a main computer or control device for further actions which is used in plant automation. If item 5 is set for pulsed output, every time item 3 sensor detects presence of item 8 target, item 2 circuit board will send a signal to the computer. Once factor 11 increases and item 3 sensor loses presence of item 8 target, item 2 circuit board does not send a signal to the computer. This on/off signal output action is what is referred to as a pulsed output. If item 5 slide switch is set to constant output, once item 3 sensor detects presence of item 8 target, item 2 circuit board sends a signal to the computer. Even though factor 11 increases and item 3 sensor looses presence of item 8 target, the output of item 2 circuit board will remain. This output remains high until item 3 sensor looses the detect/not detect sequence of item 8 target. This sequence can further be defined as being “wait and see process”. In other words, once item 3 senses item 8, item 2 starts sending a signal to the computer. Even though factor 11 increases and item 3 looses presence of item 8, item 2 still sends a signal. Item 2 will continue sending a signal until its pre-set time of waiting for item 4 to re-acquire presence with item 8 is exhausted. This pre-set time can only be changed by programming item 2 circuit board.

Item 6 push button switch is used to program a percentage based dropout of signal from item 2 circuit board. Although item 6 purpose looks to be closely similar with the previous description of item 5 when set to constant signal, it should be noted that item 6 is not time based but rather functions on a percentage basis. This percentage is based on the timing of repetitive target sensing between item 3 and item 8. If item 6 push button is depressed during normal operation, a set-point is recorded which will cause item 2 circuit board to terminate the signal output to its associated computer or control when the speed of the sensed device falls below a pre-programmed percentage of that set-point.

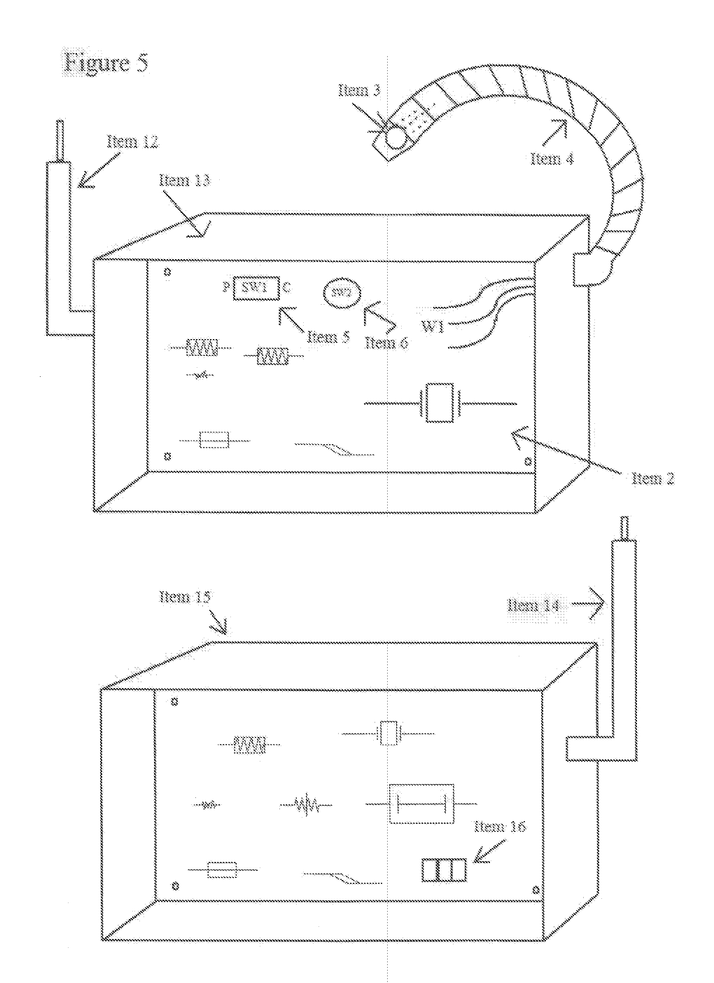

Referring to FIG. 5, we see the wireless version of the apparatus. It should be noted that item 13 operates within the same principles as the previous apparatus description except for the fact that it sends its signal wirelessly to a dedicated receiver item 15 via a signal transceiver module. Item 12 is a broadcast antenna. Item 15 is the wireless receiver that acquires the signal from item 13 thru its signal transceiver module. Item 14 is the receiving antenna. Item 5 and item 6 on FIG. 5 operate exactly the same as previously described in FIG. 1. Item 15 has contacts item 16 where the customer can attach signal wires that are routed to the control or computer. Of course, item 13 and item 15 have covers that are similar to item 7 on FIG. 1.

What is claimed is:

1. A simplified and comprehensive apparatus to detect motion comprising:
a sensor that has an extended sensing distance
a flexible conduit for sensor
a resilient conduit for sensor
a compressive circuit board
a target magnet

2. The apparatus of claim 1 further comprising:
an enclosure for mounting sensor, conduit and circuit board
an enclosure cover

3. The apparatus of claim 1 further comprising:
mounting magnets for enclosure

4. The apparatus of claim 1 further comprising:
a wireless signal transceiver module imbedded in circuit board
a transceiver antenna

5. The apparatus of claim 1 further comprising:
a wireless signal transceiver module imbedded in circuit board
a wireless signal transceiver antenna

6. The apparatus of claim 1 further comprising:
a manual switch for output selection
a pushbutton switch for selection of under speed condition

7. An apparatus for providing a target consisting of:
a target magnet

8. The apparatus of claim 6 comprising:
a housing for target magnet

9. The apparatus of claim 6 comprising:
a mounting magnet for housing
